(19) United States
(12) Patent Application Publication
(10) Pub. No.: US 2007/0234024 A1
(43) Pub. Date: Oct. 4, 2007

(54) Method for managing setup programs

(75) Inventor: Ying-Chih Lu, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/394,068

(22) Filed: Mar. 29, 2006

(51) Int. Cl. G06F 15/177

(52) U.S. Cl. 713/1

(57) ABSTRACT

The method for managing setup programs is applicable to a data processing device with a main OS setup program. The data processing device is coupled to at least one peripheral device with a configuration memory module and a corresponding configuration memory module setup program. The method checks the authority of the user. The authorized user is allowed to set identification and activation codes of the configuration memory module setup program to be disabled. When the BIOS of the data processing device detects the configuration memory module during POST, it is determined whether the identification code of the configuration memory module matches with the identification code set by the user. If so, then the configuration memory module setup program is disabled and the configuration setup procedure for the peripheral device is performed via the main OS setup program upon receiving the corresponding activation code inputted by the user.

### FIELD OF THE INVENTION

The present invention relates to a method for managing setup programs, and more particularly, to a method for managing setup programs applicable to a data processing device with a peripheral device having a main OS setup program and a configuration memory module setup program that are both capable of setting configuration of the peripheral device.

### BACKGROUND OF THE INVENTION

Generally, there are two ways of executing a configuration setup procedure of a peripheral device (e.g. Peripheral Component Interconnect (PCI) peripheral device) connected to a data processing device (e.g. a computer). One way is to execute it through a utility program of the Operating System (OS) of the data processing device. The other method is to directly execute it through a utility program corresponding to an Option ROM (OpROM) on a peripheral device for storing configuration data required when connecting the peripheral device to the data process system.

If a system manager executes the configuration setup procedure via the utility program corresponding to the OpROM on the peripheral device, the system manager would not want other people to deliberately or inadvertently change the configuration data that is already being set after configuration setup procedure is completed. However, currently there is no protection mechanism to protect the configuration data in a peripheral device that has already completed setup of the configuration data. That is, other users may directly use the utility program corresponding to the OpROM on the peripheral device to alter the configuration data. Accordingly, this is not only troublesome to the system manager, but may also cause a system crash if the configuration data is not appropriately set.

In addition, if the configuration setup procedure can be set through both the utility program of the OS of the data processing device and the utility program corresponding to the OpROM on the peripheral device, this may cause confusion to the system manager.

Thus, there is need to provided a high security configuration setup procedure.

### SUMMARY OF THE INVENTION

In the light of forgoing drawbacks, an objective of the present invention is to provide a method for managing setup programs that enhances security of configuration setup procedures.

Another objective of the present invention is to provide a method for managing setup programs that allows users to select a desired setup program to be used for setting configuration of peripheral devices in a data processing device.

Yet another objective of the present invention is to provide a method for managing setup programs that restricts a configuration setup procedure to be performed by only one setup program at a time.

In accordance with the above and other objectives, the present invention provides a method for managing setup programs that is applicable to a data processing device with a main OS and a corresponding main OS setup program. The data processing device is coupled to at least one peripheral device with a configuration memory module and a corresponding configuration memory module setup program. The method of the present invention first allows a management code for controlling right of users to manage the configuration memory module setup program of the peripheral device to be set, such that a management interface is then provided to a user with the matching management code (i.e. an authorized user). Then, identification and activation codes of the configuration memory module setup program of those peripheral devices that are -desired to be disabled are set by the user. When a basic input/output module of the data processing device detects the configuration memory module of a peripheral device during a POST detecting process, it is determined whether the identification code of the configuration memory module of the peripheral device matches with the identification code set by the user. If so, then the configuration memory module setup program is disabled upon receiving the activation code corresponding to that configuration memory module setup program inputted by the user via the data processing device. If not, then the configuration memory module setup program is enabled upon receiving the activation code corresponding to that configuration memory module setup program inputted by the user via the data processing device. If the configuration memory module setup program is disabled, then the configuration setup procedure for the peripheral device is performed via the main OS setup program of the data processing device. On the contrary, if the configuration memory module setup program is enabled, then the configuration setup procedure for the peripheral device is performed via the configuration memory module setup program of the peripheral device.

Compared to the prior art, the present invention not only provides safe management of setup programs, but also restricts the configuration setup procedure to be performed by only one setup program at a time, and such restriction is controlled by the system manager. Thus, the system manager will not be confused and the security of the configuration setup procedure is enhanced.

### BRIEF DESCRIPTION OF THE DRAWINGS

The present invention can be more fully understood by reading the following detailed description of the preferred embodiments, with reference made to the accompanying drawings, wherein:

FIG. 1 is an operational flowchart of the method for managing setup programs of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

The preferred embodiment of the method for managing setup programs of the present invention is described below in conjunction with the appended drawing. However, it should be noted that the drawing only describes the basic steps related to the embodiment of the present invention. The actual implementing steps may be more complicated than those shown herein.

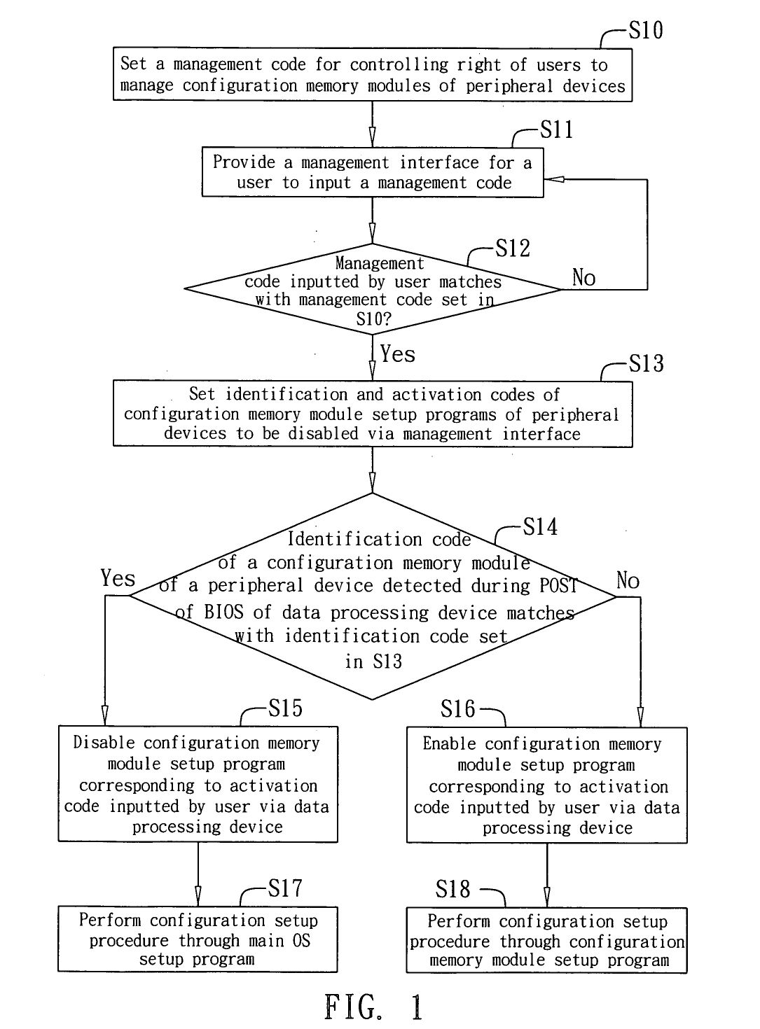

FIG. 1 is an operational flowchart of the method for managing setup programs of the present invention. The method for managing setup programs of the present invention can be applied to a data processing device. The data processing device may comprise a main OS and a corresponding main OS setup program. The data processing device is coupled to at least one peripheral device, which may comprise a configuration memory module and a corresponding configuration memory module setup program. The data processing device may further comprise a BIOS (Basic Input/Output System) for executing a detecting process to detect the peripheral devices coupled to the data processing device. The configuration memory module setup program comprise an identification code for identifying the peripheral device to which the configuration memory module setup program corresponds and an activation code for activating the configuration setup of a peripheral device.

In this embodiment, the main OS system setup program refers to an OS utility program. The configuration memory module refers to an Option ROM (OpROM) and the configuration memory module setup program refers to an OpROM utility program. The peripheral devices may be Peripheral Component Interconnect (PCI) peripheral devices (e.g. PCI cards). The data processing device is a connected to the peripheral devices via a PCI bus. The data processing device is for example a server, a desktop computer or a notebook etc. The detecting process performed by the BIOS is a Power On Self-Test (POST). The identification code may comprise a vendor ID and/or device ID. The activation code comprise machine codes that can be recognized by the data processing device and is converted from a set of hot keys (e.g. a combination of “ctr”l key+“a” key) pressed by users in order to activate the configuration setup procedure of a peripheral device. The machine code may comprise ASCII codes and scan codes.

Each step of the method for managing setup programs of the present invention will now be described as follows.

As shown, the method for managing setup programs first executes step S10.

In step S10, a management code is set. This management code is used for controlling the right to manage the configuration memory module setup program of every peripheral device, and is only known to the system manager. Next, go to step S11.

In step S11, a management interface for inputting the management code is provided for users. In this embodiment, the management code in step S10 is set in a basic input/output module, and the management interface in step S11 refers to a basic input/output module setup program used for performing configuration setup for the basic input/output module, wherein the basic input/output module is the BIOS and the basic input/output mode setup program is a BIOS setup utility program. Nonetheless, the management code can also be set via a software tool, and so as the management interface in step S11. Next, proceed to step S12.

In step S12, it is determined whether the management code inputted by a user matches the management code set in step S10. If so, go to step S13; else return to step S11. This step is used for checking the identity of the user to see if the user is authorized to manage.

In step S13, the identification code and the activation code for the configuration memory module setup program of a peripheral device to be disabled are set via the management interface by the user. In this embodiment, the identification and activation codes set by the user are stored in a storage unit (e.g. NVRAM, Flash ROM, EEPROM, HD or CMOS). The user is able to set the identification and activation codes of the configuration memory module setup program of the peripheral device to be disabled by adding these identification and activation codes to the storage unit. On the contrary, if the user wishes to enable the configuration memory module setup program of a peripheral device, the user can do so by removing the identification and activation codes from the storage unit. The identification and activation codes have been described above, so they will not be further detailed. Next, go to step S14.

In step S14, the detecting process is performed by the BIOS of the data processing module, and when the configuration memory module of a peripheral device is detected, it is determined whether the identification code corresponding to the configuration memory module of the peripheral device matches with the identification code set by the user. If so, then go to step S15; else go to step S16. In this embodiment, the identification code of the configuration memory module of a peripheral device is extracted automatically from a register (e.g. vendor ID/device ID from a PCI configuration Space) and the extracted identification code is compared with the identification code set in step S13.

In step S15, when the activation code for the corresponding configuration memory module setup program inputted to the data processing device via the user is received, the configuration memory module corresponding to the activation code is disabled. In actual implementation, the activation code can for example be intercepted via INT9 ISR of the BIOS in order to disable the configuration memory module setup program that corresponds to the activation code. That is, when the identification code corresponding to the configuration memory module of the peripheral device is identical to the identification code set by the user and the activation code corresponding to the configuration memory module setup program inputted by the user via the data processing device is received, the configuration memory module setup program corresponding to the activation code is disabled. Next, go to step S17.

In step S16, when the activation code for the corresponding configuration memory module setup program inputted to the data processing device via the user is received, the configuration memory module corresponding to the activation code is enabled. In actual implementation, the activation code can be not intercepted via INT9 ISR of the BIOS in order to enable the configuration memory module setup program that corresponds to the activation code. That is, when the identification code corresponding to the configuration memory module of the peripheral device does not match with the identification code set by the user and the activation code corresponding to the configuration memory module setup program inputted by the user via the data processing device is received, the configuration memory module setup program corresponding to the activation code is enabled. Next, go to step S18.

In step S17, the configuration setup procedure for the peripheral device is performed through the main OS setup program since the configuration memory module setup program corresponding to the activation code is already disabled.

In step S18, the configuration setup procedure for the peripheral device is performed through the configuration memory module setup program since the configuration memory module setup program corresponding to the activation code is enabled.

The technical features and details of the present invention can be understood from the description and the drawing above. The method for managing setup programs first allows a management code for managing the configuration memory module setup program of each peripheral device to be set, so that a management interface is provided to a user with the matching management code. Then, the identification and activation codes of the configuration memory module setup program of those peripheral devices that are desired to be disabled are set by the user. When the basic input/output module of the data processing device performs the detecting process, and detects the configuration memory module of a peripheral device, it is determined whether the identification code of the configuration memory module of the peripheral device matches with the identification code set by the user. If so, then the configuration memory module setup program is disabled upon receiving the activation code corresponding to that configuration memory module setup program inputted by the user via the data processing device. If not, then the configuration memory module setup program is enabled upon receiving the activation code corresponding to that configuration memory module setup program inputted by the user via the data processing device. If the configuration memory module setup program is disabled, then the configuration setup procedure for the peripheral device is performed via the main OS setup program of the data processing device. On the contrary, if the configuration memory module setup program is enabled, then the configuration setup procedure for the peripheral device is performed via the configuration memory module setup program of the peripheral device.

Therefore, the present invention not only provides safe management of setup programs, but also restricts the configuration setup procedure to be performed by only one setup program at a time, and such restriction is controlled by the system manager. Thus, the system manager will not be confused and the security of the configuration setup procedure is enhanced.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A method for managing setup programs, applicable to a data processing device comprising a main Operating System (OS) and a corresponding main OS setup program coupled to at least one peripheral device comprising a configuration memory module and a corresponding configuration memory module setup program, the data processing device further comprising a basic input/output module for performing a detecting process to detect any peripheral device coupled to the data processing device, the method comprising the steps of:
(1) determining whether a management code inputted via a management interface by a user corresponds to a predetermined management code, if so, going to step (3); else returning to step (1);
(2) setting by the user via the management interface an identification code for identifying the configuration memory module setup program of the peripheral device to be disabled and an activation code for activating a configuration setup procedure for the peripheral device;
(3) upon the configuration memory module of the peripheral device being detected during the detecting process of the basic input/output module of the data processing device, determining whether the identification code corresponding to the configuration memory module of the peripheral device being detected matches with the identification code set by the user, if so, going to step (4); else, going to step (5);
(4) upon the activation code corresponding to the configuration memory module setup program of the peripheral device being received from the user via the data processing device, disabling the configuration memory module setup program corresponding to the activation code, and performing the configuration setup procedure for the peripheral device through the main OS setup program; and
(5) upon the activation code corresponding to the configuration memory module setup program of the peripheral device being received from the user via the data processing device, enabling the configuration memory module setup program corresponding to the activation code, and performing the configuration setup procedure for the peripheral device through the configuration memory module setup program.

2. The method for managing setup programs of claim 1, wherein the main OS is an Operating System of the data processing device.

3. The method for managing setup programs of claim 2, wherein the main OS setup program is an OS utility program.

4. The method for managing setup programs of claim 1, wherein the configuration memory module is an Option Read Only Memory (OpROM).

5. The method for managing setup programs of claim 4, wherein the configuration memory module setup program is an OpROM utility program.

6. The method for managing setup programs of claim 1, wherein the at least one peripheral device is at least one Peripheral Component Interconnect (PCI) peripheral device.

7. The method for managing setup programs of claim 6, wherein the data processing device is connected to the at least one PCI peripheral device via a PCI interface.

8. The method for managing setup programs of claim 1, wherein the data processing device is a server.

9. The method for managing setup programs of claim 1, wherein the data processing device is a desktop computer.

10. The method for managing setup programs of claim 1, wherein the data processing device is a notebook computer.

11. The method for managing setup programs of claim 1, wherein the detecting process is a Power On Self-Test (POST).

12. The method for managing setup programs of claim 1, wherein the basic input/output module is a Basic Input/Output System (BIOS).

13. The method for managing setup programs of claim 1, wherein the identification code comprises at least one of a vendor identification and a device identification.

14. The method for managing setup programs of claim 1, wherein the activation code comprises a machine code that is recognizable by the data processing device and is converted from a set of hot keys pressed by the user in order to activate the configuration setup process of the peripheral device, wherein the machine code may comprise ASCII codes and scan codes.

15. The method for managing setup programs of claim 1, wherein the management code is set in the basic input/output module and the management interface is a basic input/output module setup program for setting configuration of the basic input/output module.

16. The method for managing setup programs of claim 15, wherein the basic input/output module is a BIOS.

17. The method for managing setup programs of claim 15, wherein the basic input/output module setup program is a BIOS setup utility program.

18. The method for managing setup programs of claim 1, wherein the management code is set in a software tool and the management interface is provided by the software tool.

19. The method for managing setup programs of claim 1, wherein the identification code and the activation code set in the step (2) are stored in a storage unit.
